(19) United States
(12) Patent Application Publication
(10) Pub. No.: US 2016/0356001 A1
(43) Pub. Date: Dec. 8, 2016

(54) METHOD OF MEASURING ROAD STATE, METHOD OF IDENTIFYING DEGRADATION POINT OF ROAD SURFACE, INFORMATION PROCESS APPARATUS, AND NON-TRANSITORY COMPUTER-READABLE RECORDING MEDIUM

(71) Applicant: FUJITSU LIMITED, Kawasaki-shi (JP)

(72) Inventors: Takashi SHIMADA, Shinagawa (JP); Hiroyuki TANI, Katsushika (JP); Kosei Takano, Fujimino (JP)

(73) Assignee: FUJITSU LIMITED, Kawasaki-shi (JP)

(21) Appl. No.: 15/240,285

(22) Filed: Aug. 18, 2016

Related U.S. Application Data
(63) Continuation of application No. PCT/JP2015/051404, filed on Jan. 20, 2015.

(30) Foreign Application Priority Data
Mar. 18, 2014 (JP) 2014-054490

(51) Int. Cl. E01C 23/00; G06T 7/00; G06K 9/00; E01C 1/00

(52) U.S. Cl. CPC E01C 23/00; E01C 1/002; G06T 7/0004; G06K 9/00798; G06T 2207/30256

(57) ABSTRACT

In a method of measuring a road state, the method includes extracting, based on measurement values of an acceleration sensor obtained when a vehicle having the acceleration sensor installed therein travels a predetermined road section, a measurement target section in which an MCI value is to be measured, the measurement target section being a part of the predetermined road section and including a road surface that meets a predetermined degradation criteria; and limiting, to the measurement target section that is the part of the predetermined road section, a measurement target in which the MCI value is to be measured using a road surface condition measurement vehicle having laser scanning and camera image capturing functions.

### CROSS-REFERENCE TO RELATED APPLICATIONS

This is a continuation of International Application No. PCT/JP2015/051404, filed on Jan. 20, 2015, which is based upon and claims the benefit of priority of the prior Japanese Patent Application No. 2014-054490, filed on Mar. 18, 2014, the entire contents of which are incorporated herein by reference.

### FIELD

The present invention is related to a method of measuring a road state, a method of identifying a degradation point of a road surface, an information process apparatus, and a program.

### BACKGROUND

Conventionally, there is a case where subsidy from Land, Infrastructure and Transportation Ministry, etc., is used for cost related to repair work, etc., for a road surface. The subsidy is supplied according to an evaluation result of a road surface state based on an MCI (Maintenance Control Index) value derived from road surface condition examination, for example. Thus, conventionally, in inspecting the road surface, the road surface condition examination with a road surface condition vehicle is performed with respect to a road section to be inspected to derive the MCI value thereof.

### CITATION LIST

### Patent Literature 1

[PTL 1]
Japanese Laid-open Patent Publication No. 2013-139671

[PTL 2]
Japanese Laid-open Patent Publication No. 2012-012792

However, if the MCI values are derived with respect to all the road sections to be inspected, massive time and human effort are used for the road surface condition examinations, analysis of the examinations, etc., which leads to increased cost.

### SUMMARY

According to an embodiment, a method of measuring a road state includes extracting, based on measurement values of an acceleration sensor obtained when a vehicle having the acceleration sensor installed therein travels a predetermined road section, a measurement target section in which an MCI value is to be measured, the measurement target section being a part of the predetermined road section and including a road surface that meets a predetermined degradation criteria, and limiting, to the measurement target section that is the part of the predetermined road section, a measurement target in which the MCI value is to be measured using a road surface condition measurement vehicle having laser scanning and camera image capturing functions.

The object and advantages of the embodiment will be realized and attained by means of the elements and combinations particularly pointed out in the claims. It is to be understood that both the foregoing general description and the following detailed description are exemplary and explanatory and are not restrictive of the invention.

### BRIEF DESCRIPTION OF DRAWINGS

FIG. 1 is a diagram illustrating an example of a measurement system of a road surface state.

FIG. 2 is a diagram illustrating a hardware configuration of a portable terminal.

FIG. 3 is a diagram illustrating a hardware configuration of a server apparatus.

FIG. 4 is a diagram illustrating a hardware configuration of a road surface condition measurement apparatus.

FIG. 5 is a diagram illustrating a function configuration of the portable terminal.

FIG. 6 is a diagram illustrating an example of measurement information stored in the portable terminal.

FIG. 7 is a diagram illustrating a function configuration of the server apparatus.

FIG. 8 is a diagram illustrating an example of road surface degradation position information generated in the server.

FIG. 9 is a diagram illustrating an example of kilometer post layout position information generated in the server.

FIG. 10 is a diagram illustrating an example of mapping information stored in the server.

FIG. 11 is a diagram illustrating an example of measurement target section information stored in the server.

FIG. 12 is a flowchart of a generation process of the measurement target section information executed in the server.

FIG. 13 is a diagram explaining a generation of the measurement target section information.

FIG. 14 is a flowchart of an output process of the measurement target section information executed in the server.

FIG. 15 is a diagram illustrating a function configuration of the road surface condition measurement apparatus.

FIG. 16 is a contrasting diagram explaining an effect of cut cost related to an inspection of the road surface.

FIG. 17 is a first diagram explaining an effect of cut cost related to the inspection of the road surface.

FIG. 18 is a diagram illustrating another example of measurement target section information stored in the server.

FIG. 19 is a diagram illustrating another function configuration of the road surface condition measurement apparatus.

FIG. 20 is a second diagram explaining an effect of cut cost related to the inspection of the road surface.

FIG. 21 is a diagram illustrating another example of a measurement system of a road surface state.

### DESCRIPTION OF EMBODIMENTS

In the following, embodiments will be described by referring to the accompanying drawings. It is noted that elements that have substantially the same functional configuration are given the same reference number in the specification and the drawings, and redundant explanation thereof is omitted.

### First Embodiment

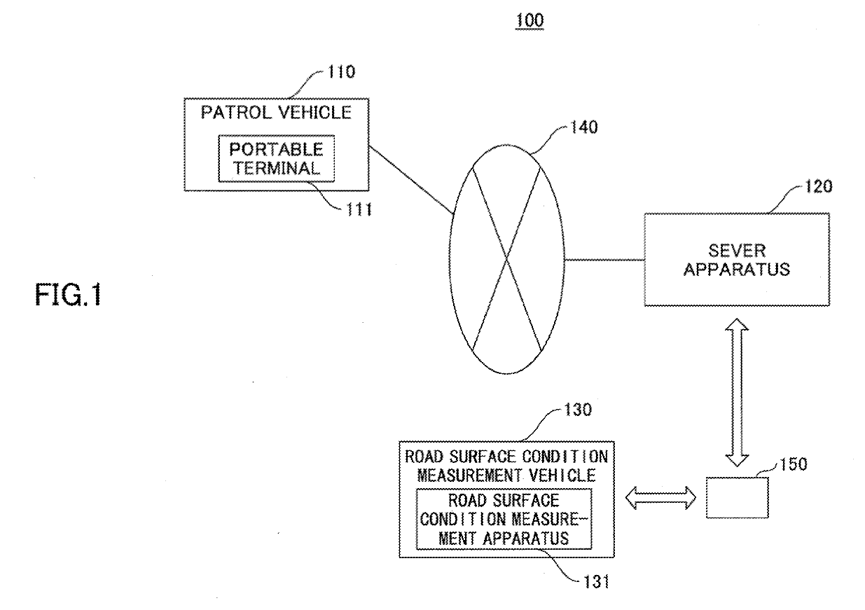

At first, a measurement system of a road surface state according to a first embodiment is explained. FIG. 1 is a diagram illustrating an example of a measurement system of a road surface state.

As illustrated in FIG. 1, a measurement system 100 of a road surface state includes a portable terminal 111 and a server apparatus 120. The portable terminal 111 is installed in a patrol vehicle 110. Further, the server apparatus 120 is coupled to the portable terminal 111 via a network 140. Further, the server apparatus 120 exchanges information with a road surface condition measurement apparatus 131 installed in a road surface condition measurement vehicle 130, via a predetermined recording medium 150, for example. It is noted that the information may be exchanged between the server apparatus 120 and the road surface condition measurement apparatus 131 via the recording medium 150 described above, for example, or the information may be exchanged in other ways.

The patrol vehicle 110 patrols for the road surface state, and regularly travels in road sections to be patrolled. The portable terminal 111 is a smart terminal such as a smart phone, a tablet terminal, etc., and measures information related to vibration of the patrol vehicle 110 and the information related to the position of the patrol vehicle 110. Further, the portable terminal 111 transmits the information thus obtained as measurement information to the server apparatus 120.

The server apparatus 120 determines whether there is degradation of the road surface based on the measurement information transmitted from the portable terminal 111, and identifies a position (referred to as “road surface degradation position”, hereinafter) of the road surface for which it is determined that there is degradation. Further, the server apparatus 120 determines which kilometer post section includes the identified road surface degradation position and which road section includes the kilometer post section including the identified road surface degradation position. Further, the server apparatus 120 obtains information related to the kilometer post section, which is included in the road section for which the road surface state is to be inspected and includes the road surface degradation position, and generates measurement target section information. The measurement target section information is given to the road surface condition measurement apparatus 131. It is noted that, in the following, the road section whose road surface state is to be inspected is referred to as “inspection target road section”.

It is noted that the kilometer post is a road post indicating a distance from a predetermined start point, and is disposed every 1 km or 100 m. Further, the kilometer post section starts from a certain kilometer post and ends at the next kilometer post (i.e., the section between the neighboring kilometer posts).

The road surface condition measurement vehicle 130 travels on the inspection target road section. The road surface condition measurement apparatus 131 performs measurement (referred to as “road surface condition measurement”) such as a step measurement of the road with a laser scan unit, road surface imaging with a camera image capturing part, etc., in order to derive MCI (Maintenance Control Index) values. Further, the road surface condition measurement apparatus 131 measures information related to the position of the road surface condition measurement vehicle 130. The road surface state measurement with the road surface condition measurement apparatus 131 is performed based on the measurement target section information, which is supplied from the server apparatus 120, for example.

In this way, according to the measurement system 100 of the road surface state, the kilometer post section including the road surface degradation position is identified based on the measurement information obtained from the portable terminal 111 installed in the patrol vehicle 110. The road surface condition measurement apparatus 131 performs the road surface condition measurement in the identified kilometer post section. In other words, according to the measurement system 100 of the road surface state, the section in which the road surface condition measurement is to be performed with the road surface condition measurement apparatus 131 is limited within the inspection target road section.

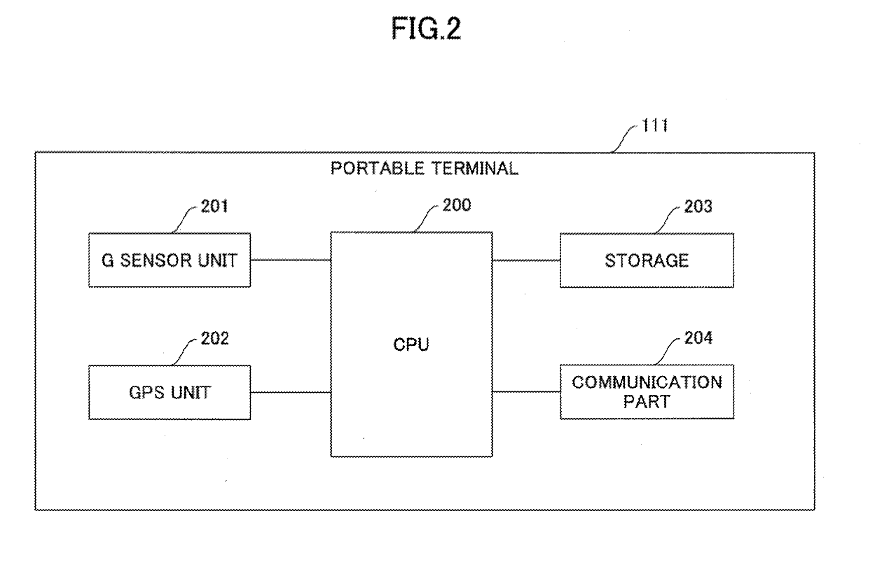

Next, the portable terminal 111 is described in detail. FIG. 2 is a diagram illustrating a hardware configuration of the portable terminal. The portable terminal 111 includes a CPU (Central Processing Unit) 200, a G (Gravitation) sensor unit 201, a GPS (Global Positioning System) unit 202, a storage 203, and a communication part 204.

The G sensor unit 201 detects acceleration in an up-and-down direction as information related to the vibration of the patrol vehicle 110. With this arrangement, it becomes possible to detect the vibration of the patrol vehicle 110 due to the degradation of the road surface such as depressions, wheel tracks, cracks, etc., of the road.

The GPS unit 202 detects latitude and longitude as the information related to the position of the portable terminal 111.

The CPU 200 executes programs stored in the storage 203. The storage 203 stores programs installed in the portable terminal 111, data obtained by calculations by the CPU 200, etc.

The communication part 204 transmits, based on an instruction from the CPU 200, the measurement information stored in a measurement information DB 220.

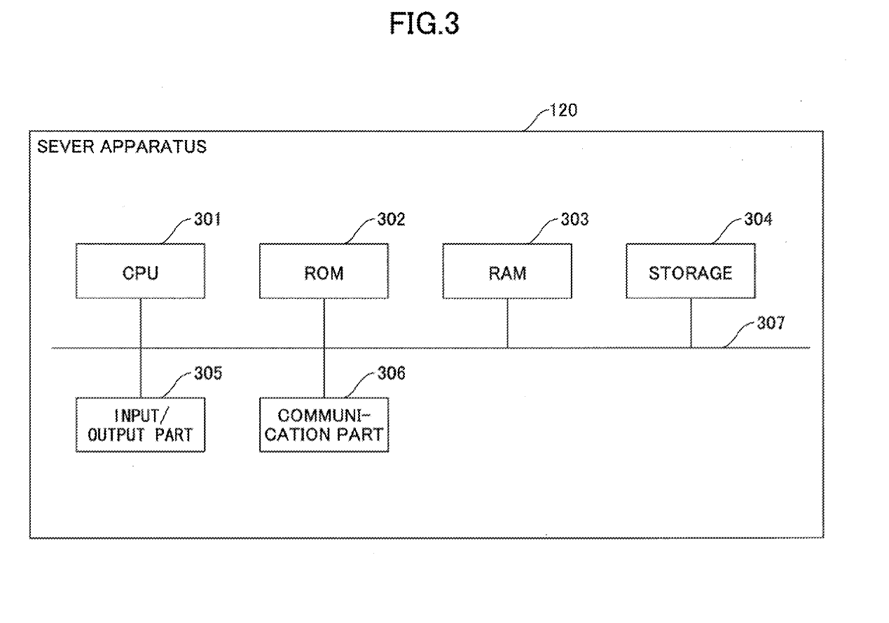

Next, the server apparatus 120 is described in detail. FIG. 3 is a diagram illustrating a hardware configuration of the server apparatus. The server apparatus 120 includes a CPU 301, a ROM (Read Only Memory) 302, and a RAM (Random Access Memory) 303. Further, the server apparatus 120 includes a storage 304, an input/output part 305, and a communication part 306. It is noted that parts of the server apparatus 120 are coupled to each other via a bus 307.

The CPU 301 executes programs stored in the storage 304.

The ROM 302 is a nonvolatile memory. The ROM 302 stores programs, data, etc., required for the CPU 301 to execute the programs stored in the 304. Specifically, boot programs such as BIOS (Basic Input/Output System), EFI (Extensible Firmware Interface), etc., are stored.

The RAM 303 is a main memory such as DRAM (Dynamic Random Access Memory), SRAM (Static Random Access Memory), etc. The RAM 303 functions as a work area in which the programs in the storage 304 are expanded at the execution by the CPU 301.

The vehicle event data receiving part 304 stores the programs installed in the server apparatus 120, data generated at the example of the programs, etc. The input/output part 305 receives instructions to the server apparatus 120. Further, the input/output part 305 displays an internal state of the server apparatus 120.

The communication part 306 communicates with the portable terminal 111, etc., via the network 140.

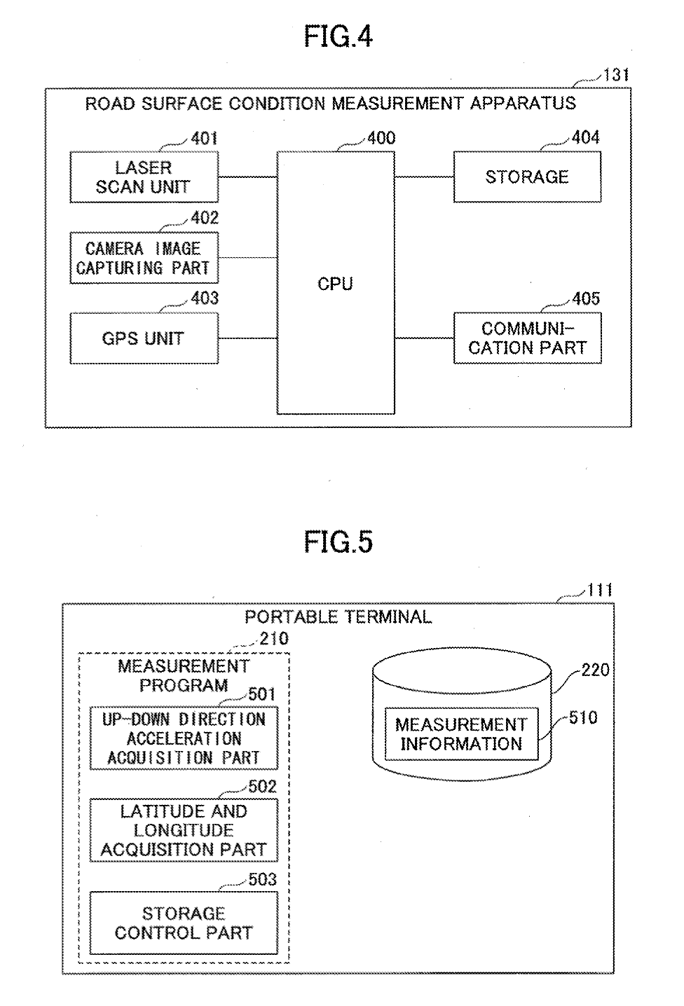

Next, the road surface condition measurement apparatus 131 is described in detail. FIG. 4 is a diagram illustrating a hardware configuration of the road surface condition measurement apparatus 131. The road surface condition measurement apparatus 131 includes a CPU 400, a laser scan unit 401, a camera image capturing part 402, a GPS unit 403, a storage 404, and a communication part 405.

The laser scan unit 401 emits laser light to the road surface, and measures a distance to a laser spot position to perform the step measurement, etc., of the road. The camera image capturing part 402 captures the image of the road surface to generate images of the road surface.

The GPS unit 403 detects latitude and longitude that form the information related to the position of the road surface condition measurement apparatus 131.

The CPU 400 executes programs stored in the storage 404. The storage 404 stores the programs to be executed by the CPU 400, measurement data, etc.

The communication part 405 performs communication with an external apparatus.

Next, a function configuration of the measurement program 210 of the portable terminal 111 is explained. FIG. 5 is a diagram illustrating a function configuration of the portable terminal.

The portable terminal 111 according to the embodiment has a measurement program 210 installed therein. The portable terminal 111 according to the embodiment implements functions of parts described hereinafter by the CPU 200 executing the measurement program 210.

Further, the portable terminal 111 according to the embodiment includes a measurement information database (“DB” stands for database, hereinafter) 220. The measurement information DB 220 according to the embodiment is provided in the storage 203, etc., for example.

The portable terminal 111 includes an acceleration acquisition part 501, a latitude and longitude acquisition part 502, and a storage control part 503.

The acceleration acquisition part 501 obtains the acceleration in the up-and-down direction detected by the G sensor unit 201. The latitude and longitude acquisition part 502 obtains the latitude and the longitude detected by the GPS unit 202. The acceleration acquisition part 501 according to the embodiment and the latitude and longitude acquisition part 502 obtains the acceleration in the up-and-down direction and the latitude and the longitude in synchronization at a predetermined cycle. The storage control part 503 stores measurement information 510 in which the acceleration in the up-and-down direction and the latitude and the longitude are associated with date and time of the acquisition thereof in the measurement information DB 220.

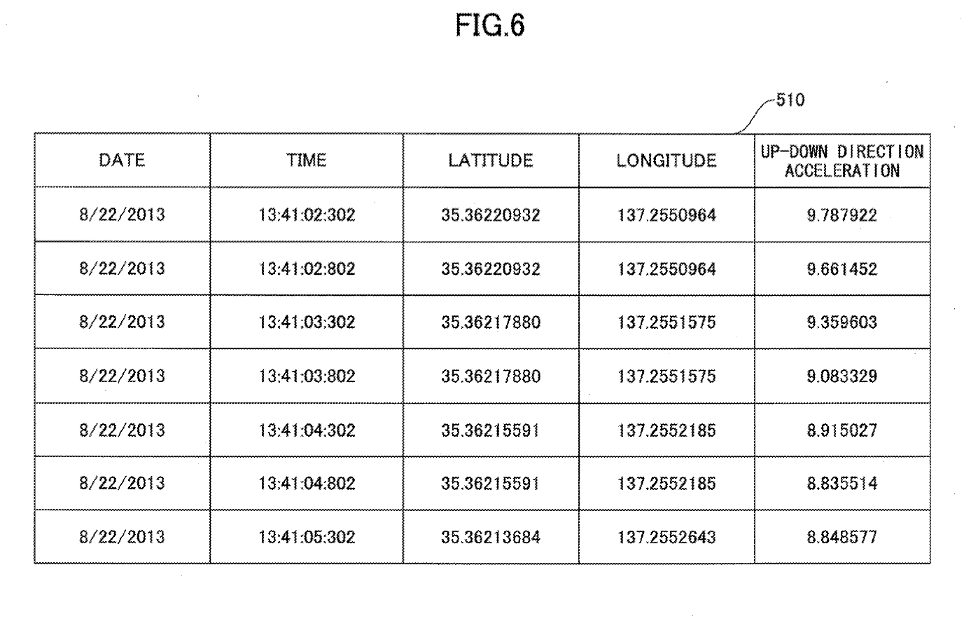

FIG. 6 is a diagram illustrating an example of the measurement information stored in the portable terminal. As illustrated in FIG. 6, the measurement information 510 includes, as items of information, “date”, “time”, “latitude”, “longitude”, and “vertical acceleration”. In the example illustrated in FIG. 6, the CPU 200 obtains the acceleration in the up-and-down direction and the latitude and the longitude at every 0.5 sec, and stores them in the measurement information DB 220.

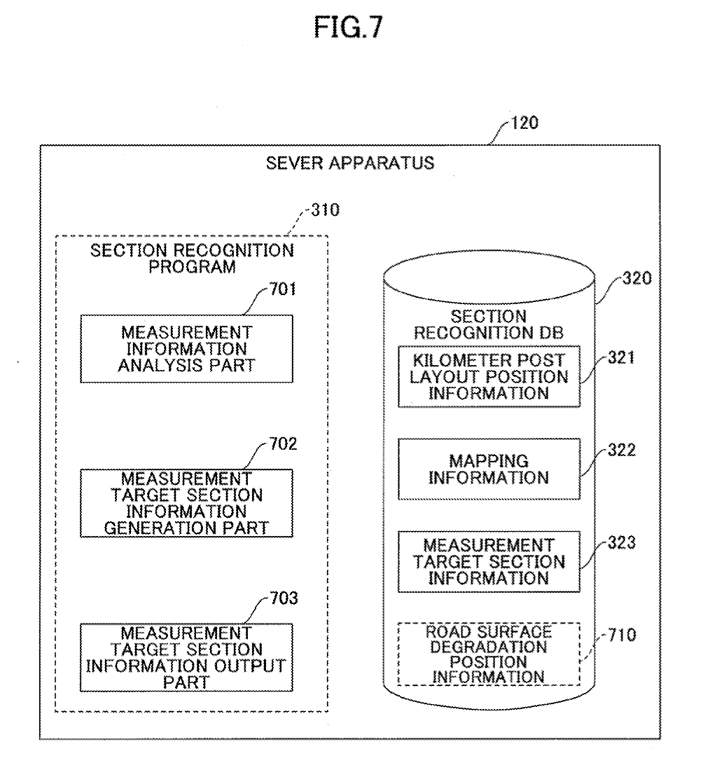

Next, a function configuration of the server apparatus 120 is described in detail. FIG. 7 is a diagram illustrating a function configuration of the server apparatus 120.

The server apparatus 120 according to the embodiment has a section recognition program 310 installed therein. The server apparatus 120 according to the embodiment implements functions of parts described hereinafter by the CPU 301 executing the section recognition program 310.

Further, the server apparatus 120 according to the embodiment includes a section recognition DB 320. The section recognition DB 320 stores kilometer post layout position information 321, mapping information 322, and the measurement target section information 323. The section recognition DB 320 is provided in the storage 304, etc., for example.

The server apparatus 120 according to the embodiment includes a measurement information analysis part 701, a measurement target section information generation part 702, and a measurement target section information output part 703.

The measurement information analysis part 701 identifies the road surface degradation position based on the measurement information 510 transmitted from the portable terminal 111 to output road surface degradation position information 710. Specifically, the acceleration in the up-and-down direction whose magnitude is greater than or equal to a predetermined threshold is recognized among the acceleration in the up-and-down direction stored in the measurement information 510, and the latitude and the longitude associated with the recognized acceleration in the up-and-down direction are extracted. Further, the measurement information analysis part 701 outputs the combination of the extracted latitude and the longitude to the measurement target section information generation part 702 as the road surface degradation position information 710. The road surface degradation position information 710 is described hereinafter in detail.

The measurement target section information generation part 702 performs matching between the road surface degradation position information 710 and the kilometer post layout position information 321 using the mapping information 322 stored in the section recognition DB 320 to generate the measurement target section information 323 and store it in the section recognition DB 320. The details of the process of the measurement target section information generation part 702 are described hereinafter.

The measurement target section information output part 703 reads the measurement target section information 323 corresponding to the inspection target road section from the section recognition DB 320 to output it to the recording medium 150 which is to be supplied to the road surface condition measurement apparatus 131.

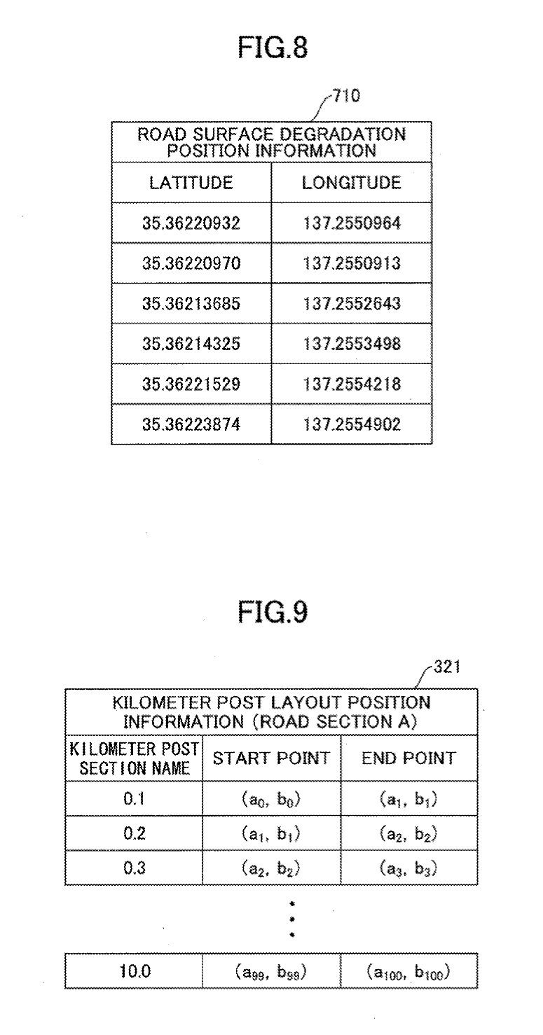

Next, a concrete example of the road surface degradation position information 710 is described. FIG. 8 is a diagram illustrating an example of road surface degradation position information generated in the server. As illustrated in FIG. 8, the road surface degradation position information 710 includes, as items of information, “latitude” and “longitude”. The combination of the value of “latitude” and the value of “longitude” of the road surface degradation position information 710 indicates the degradation position of the road surface.

Next, a concrete example of the kilometer post layout position information 321 is described. FIG. 9 is a diagram illustrating an example of the kilometer post layout position information generated in the server. It is noted that the section recognition DB 320 stores the kilometer post layout position information for a plurality of road sections, and FIG. 9 illustrates a concrete example of the kilometer post layout position information 321 with respect to “road section A” among them.

It is noted that the road section A is 10 km long and includes 100 kilometer post sections. As illustrated in FIG. 9, the kilometer post layout position information 321 includes, as items of information, “kilometer post section name”, “start point”, and “end point”.

In the “kilometer post section name”, the names of the kilometer post sections included in the road section A are stored. In the case of the road section A, the names of the kilometer post sections are numbers, and in “kilometer post section name” the numbers corresponding to the names of the kilometer post sections are stored.

In the “start point”, the combinations of the latitude and the longitude of the start points of the corresponding kilometer post sections identified by the “kilometer post section names” are stored. Further, in the “end point”, the combinations of the latitude and the longitude of the end points of the corresponding kilometer post sections identified by the “kilometer post section names” are stored. It is noted that, in the “end point” of the respective kilometer post sections, the same combinations of the latitude and the longitude as stored in the “start point” of the next kilometer post sections are stored. It is noted that, in FIG. 9, a straight road is illustrated as an example for the sake of simplifying the explanation; however, the actual road is winding, and a kilometer post section includes a plurality of reference points in addition to the start and end points.

In the example illustrated in FIG. 9, the kilometer post section whose “kilometer post section name” is “0.1” corresponds to a section between the kilometer post located at 0 m which corresponds to the start point of the road section A and the kilometer post located at 100 m from the start point. Further, the latitude and the longitude of the start point of the kilometer post section (i.e., the kilometer post located at 0 m which corresponds to the start point) whose “kilometer post section name” is “0.1” is (a0, b0), and the latitude and the longitude of the end point (i.e., the kilometer post located at 100 m from the start point) is (a1, b1).

Similarly, the kilometer post section whose “kilometer post section name” is “0.2” corresponds to a section between the kilometer post located at 100 m from the start point of the road section A and the kilometer post located at 200 m from the start point. Further, the latitude and the longitude of the start point of the kilometer post section (i.e., the kilometer post located at 100 m from the start point) whose “kilometer post section name” is “0.2” is (a1, b1), and the latitude and the longitude of the end point (i.e., the kilometer post located at 200 m from the start point) is (a2, b2). In this way, in the example illustrated in FIG. 9, as the kilometer post layout position information 321, the latitudes and the longitudes of the start points and the end points are stored for the respective kilometer post sections until the kilometer post section whose “kilometer post section name” is “10.0”.

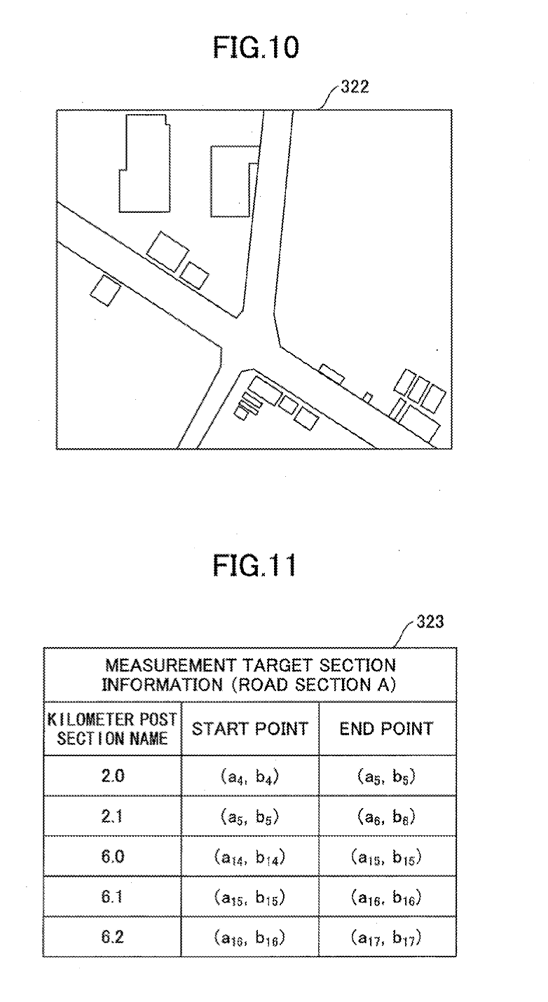

Next, a concrete example of the mapping information 322 is described. FIG. 10 is a diagram illustrating an example of the mapping information stored in the server.

The mapping information 322 according to the embodiment may be map data that is used for an ordinary car navigation apparatus, etc., for example. The mapping information 322 according to the embodiment is preferably map data with which roads can be identified, as illustrated in FIG. 10.

It is noted that, in the embodiment, the kilometer post layout position information 321 and the mapping information 322 may be stored in an external apparatus that is coupled to the server apparatus 120 via the network 140. In this case, the server apparatus 120 may refer to the kilometer post layout position information 321 and the mapping information 322 stored in the external apparatus to perform the processes of the respective parts described hereinafter.

Next, a concrete example of the measurement target section information 323 is described. FIG. 11 is a diagram illustrating an example of the measurement target section information stored in the server.

As illustrated in FIG. 11, the measurement target section information 323 includes, as items of information, “kilometer post section name”, “start point”, and “end point”.

In the “kilometer post section name”, names of one or more kilometer post sections including one or more road surface degradation positions are stored. Further, in the “start point”, the combinations of the latitude and the longitude of the start points of the corresponding kilometer post sections identified by the “kilometer post section names” are stored. Further, in the “end point”, the combinations of the latitude and the longitude of the end points of the corresponding kilometer post sections identified by the “kilometer post section names” are stored. Further, the measurement target section information 323 according to the embodiment may be generated on a road section basis, and may be stored such that the measurement target section information 323 is associated with information for identifying the corresponding road sections.

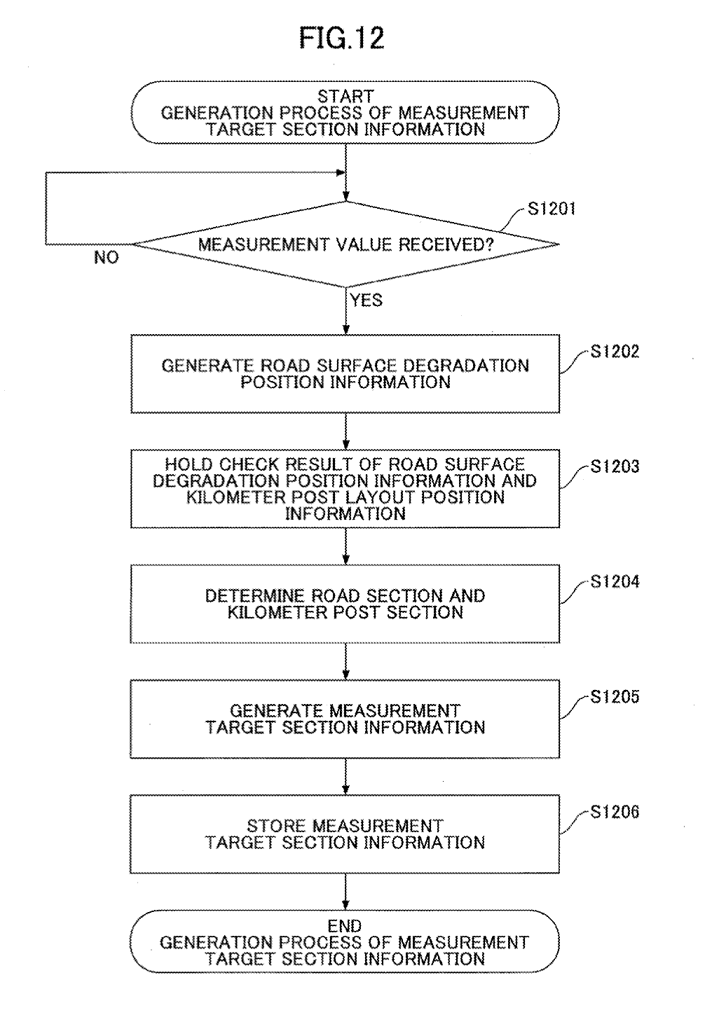

Next, a process of the measurement target section information generation part 702 in the server apparatus 120 is described. FIG. 12 is a flowchart of a generation process of the measurement target section information executed in the server.

In step S1201, the measurement information analysis part 701 determines whether the measurement information 510 is received by the portable terminal 111. If it is determined in step S1201 that the measurement information 510 is not received, the measurement information analysis part 701 waits for the reception of the measurement information 510.

On the other hand, if it is determined in step S1201 that the measurement information 510 is received, the measurement information analysis part 701 goes to step S1202. In step S1202, the measurement information analysis part 701 extracts the acceleration in the up-and-down direction whose magnitude is greater than or equal to a predetermined threshold from the received measurement information 510. Further, the measurement information analysis part 701 extracts the combination of the latitude and the longitude associated with the extracted acceleration in the up-and-down direction to generate the road surface degradation position information 710.

In step S1203, the measurement target section information generation part 702 uses the mapping information 322 to check the road surface degradation position information 710 and the kilometer post layout position information 321, and holds the check result. Specifically, the measurement target section information generation part 702 plots the position, which is determined by the combination of the latitude and the longitude included in the road surface degradation position information 710, in the mapping information 322.

Further, in step S1204, the measurement target section information generation part 702 determines, based on the check in step S1203, the kilometer post section including the road surface degradation position in the inspection target road section.

Specifically, the measurement target section information generation part 702 identifies, based on the start and end points of the respective kilometer post sections included in the kilometer post layout position information 321, the respective kilometer post sections in the mapping information 322. Further, the measurement target section information generation part 702 compares the respective kilometer post sections with the plotted road surface degradation position(s) in the mapping information 322 to determine the kilometer post section(s) in which the road surface degradation position(s) is included.

In step S1205, the measurement target section information generation part 702 extracts the combination(s) of the latitude and the longitude of the kilometer post section(s) determined in step S1204 from the kilometer post layout position information 321 to generate the measurement target section information 323.

In step S1206, the measurement target section information generation part 702 stores the measurement target section information 323 generated in step S1205 in the section recognition DB 320.

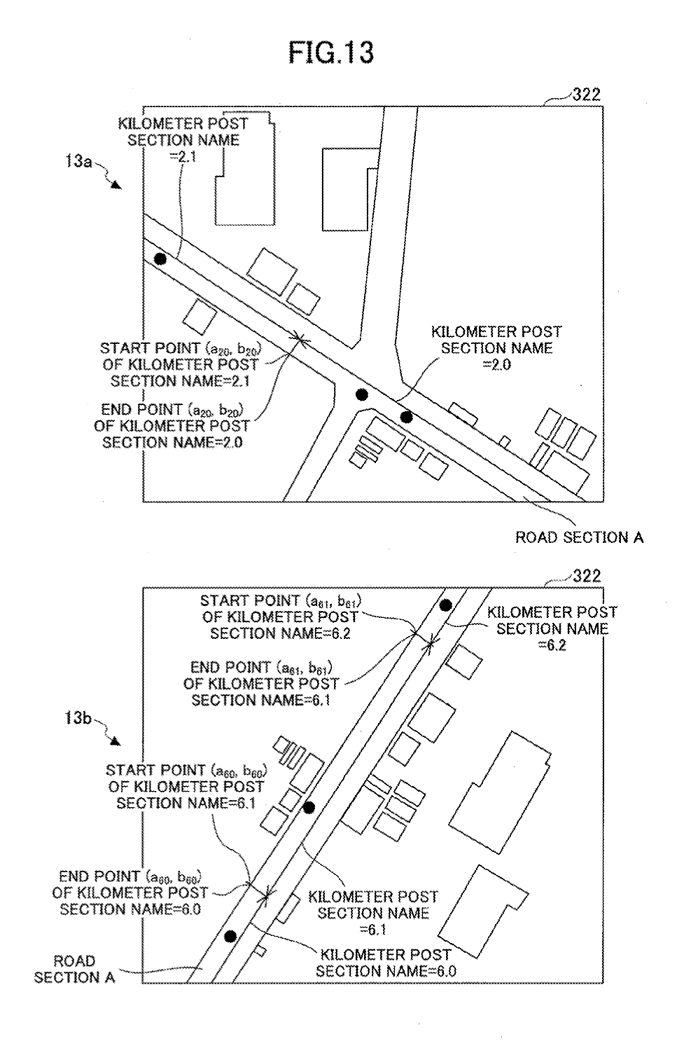

Here, with reference to FIG. 13, a generation of the measurement target section information according to the embodiment is specifically described. FIG. 13 is a diagram explaining a generation of the measurement target section information. “13a” illustrated in FIG. 13 is a first example of the measurement target section information, and “13b” illustrated in FIG. 13 is a second example of the measurement target section information.

In “13a” illustrated in FIG. 13, road surface degradation positions identified by three combinations of the latitude and the longitude, among the combinations of the latitude and the longitude included in the road surface degradation position information 710, are plotted with black circle marks with respect to the mapping information 322. Further, the end point of the kilometer post whose “kilometer post name” is “2.0” and the start point of the kilometer post whose “kilometer post name” is “2.1” are illustrated in an overlapped manner with respect to the mapping information 322.

Further, in “13b” illustrated in FIG. 13, road surface degradation positions identified by remaining three combinations of the latitude and the longitude, among the combinations of the latitude and the longitude included in the road surface degradation position information 710, are plotted with black circle marks with respect to the mapping information 322. Further, the end point of the kilometer post section whose “kilometer post name” is “6.0” and the start point of the kilometer post section whose “kilometer post name” is “6.1” are illustrated in an overlapped manner with respect to the mapping information 322.

In the examples “13a” and “13b” illustrated in FIG. 13, the measurement target section information generation part 702 determines that the road surface degradation positions identified by the combination of the latitudes and the longitudes included in the road surface degradation position information 710 are included in the road section A. Further, the measurement target section information generation part 702 determines that the road surface degradation positions are included in the kilometer post sections whose “kilometer post names” are “2.0” and “2.1”, and the kilometer post sections whose “kilometer post names” are “6.0”, “6.1”, and “6.2”.

In this way, the measurement target section information generation part 702 checks the mapping information 322, the road surface degradation position information 710, and the kilometer post layout position information 321 to identify the kilometer post section(s) in which the road surface degradation position(s) is included.

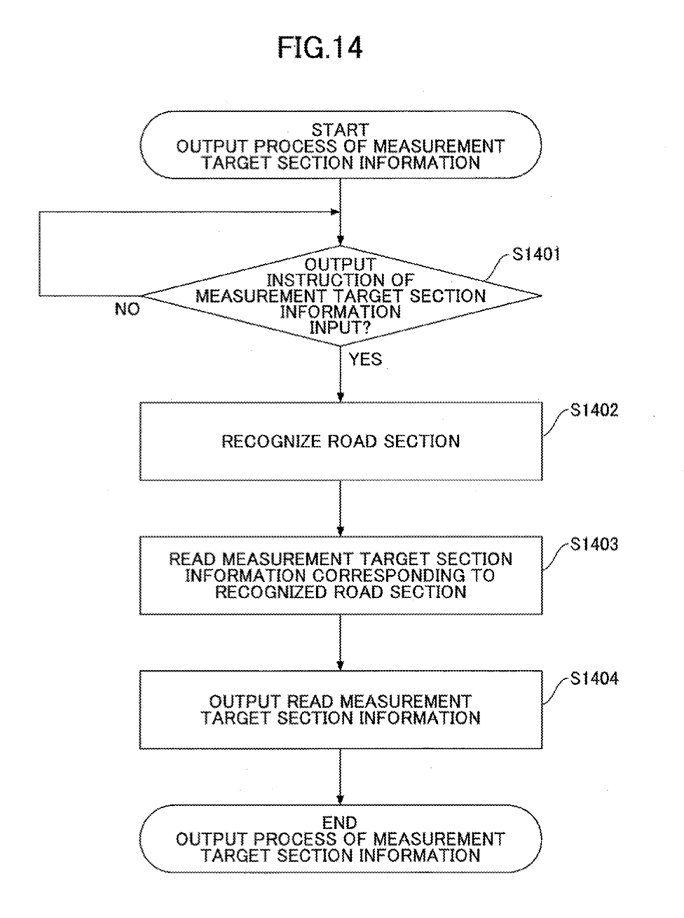

Next, a process of the measurement target section information output part 703 in the server apparatus 120 is described. FIG. 14 is a flowchart of an output process of the measurement target section information executed in the server.

In step S1401, the measurement target section information output part 703 determines whether an output instruction for the measurement target section information 323 is input. If it is determined in step S1401 that output instruction for the measurement target section information 323 is not input, the measurement target section information output part 703 waits for the input of the output instruction.

On the other hand, if it is determined in step S1401 that output instruction for the measurement target section information 323 is input, step S1402 is executed where the measurement target section information output part 703 recognizes the road section input together with the output instruction.

In step S1403, the measurement target section information output part 703 reads the measurement target section information 323 corresponding to the road section recognized in step S1402 from the section recognition DB 320.

In step S1404, the measurement target section information output part 703 outputs the measurement target section information 323 read in step S1403 to the recording medium 150 to be supplied to the road surface condition measurement apparatus 131.

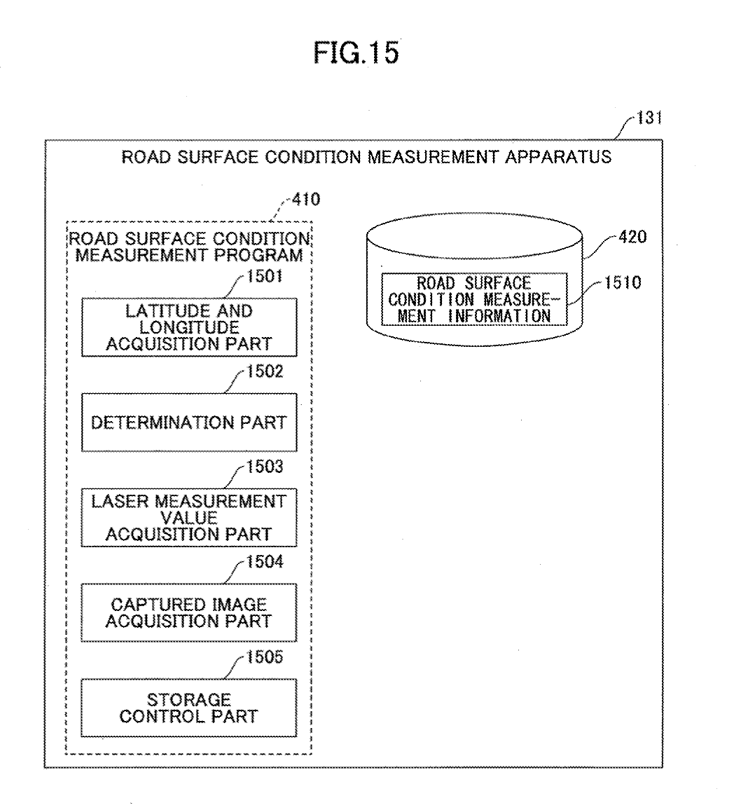

Next, a function configuration of the road surface condition measurement apparatus 131 according to the embodiment is described in detail. FIG. 15 is a diagram illustrating a function configuration of the road surface condition measurement apparatus.

The road surface condition measurement apparatus 131 according to the embodiment has a road surface condition measurement program 410 installed therein. The road surface condition measurement apparatus 131 according to the embodiment implements functions of parts described hereinafter by the CPU 400 executing the road surface condition measurement program 410.

Further, the road surface condition measurement apparatus 131 includes a road surface condition measurement information DB 420. The road surface condition measurement information DB 420 is provided in the storage 404, for example, and the road surface condition measurement information obtained by executing the road surface condition measurement program 410 is stored in the road surface condition measurement information DB 420.

The road surface condition measurement apparatus 131 according to the embodiment includes a latitude and longitude acquisition part 1501, a determination part 1502, a laser measurement value acquisition part 1503, a captured image acquisition part 1504, and a storage control part 1505.

The latitude and longitude acquisition part 1501 obtains the latitude and the longitude detected by the GPS unit 403 at predetermined cycle.

The determination part 1502 determines whether the position identified by the obtained latitude and longitude is within the kilometer post section identified by the measurement target section information 323 supplied from the server apparatus 120. Further, if the determination part 1502 determines that the position identified by the obtained latitude and longitude is within the kilometer post section identified by the measurement target section information 323, the determination part 1502 outputs an acquisition instruction to the laser measurement value acquisition part 1503 and the captured image acquisition part 1504.

The laser measurement value acquisition part 1503 obtains the laser measurement values detected by the laser scan unit 401 during a period in which the acquisition instruction is output from the determination part 1502.

The captured image acquisition part 1504 obtains the captured images captured by the camera image capturing part 402 during a period in which the acquisition instruction is output from the determination part 1502.

The storage control part 1505 stores road surface condition measurement information 1410 in which the obtained latitude and longitude, the laser measurement values, and the captured images are associated with date and time of the acquisition thereof in the road surface condition measurement information DB 420.

Next, effects obtained according to the measurement system 100 of the road surface state are described. It is noted that, in the following explanation, for the sake of contrast, a work flow for inspecting the road surface without using the measurement system 100 of the road surface state according to the first embodiment is described at first.

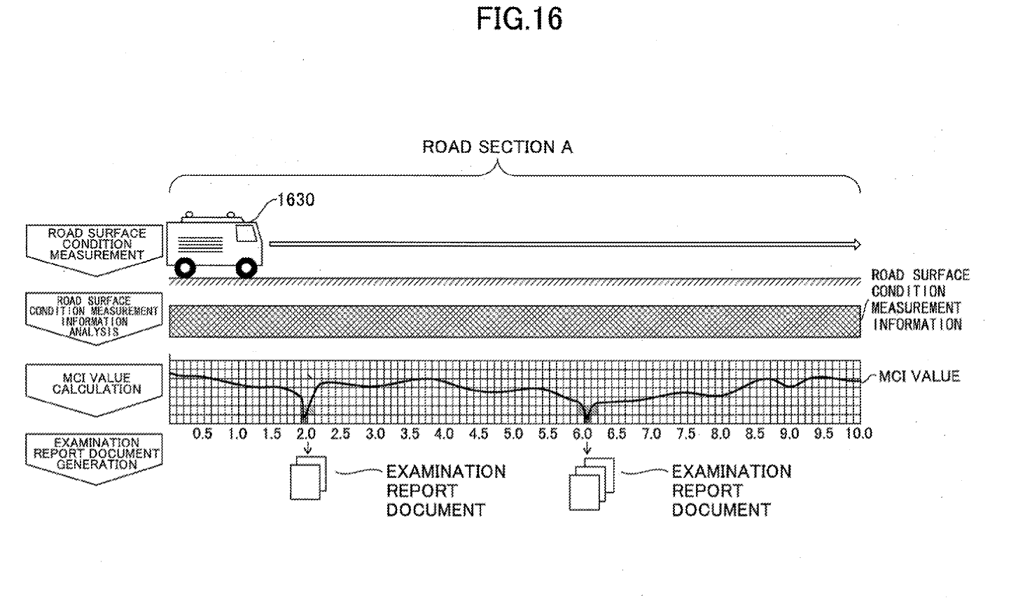

FIG. 16 is a contrasting diagram explaining an effect of cut cost related to the inspection of the road surface. As the work flow illustrated in FIG. 16, the road surface condition measurement vehicle 1630 performs the road surface condition measurement over the whole of the road section A to obtain the road surface condition measurement information. Further, the analysis on the road surface condition measurement information is performed for the whole of the road section A to derive the MCI values with respect to all the kilometer post sections included in the road section A.

Further, an inspection report document, etc., is made using the road surface condition measurement information of the kilometer post section(s) whose MCI value is less than or equal to 2, among the derived MCI values. It is noted that the inspection report document is submitted as the inspection result of the road pavement with respect to the road section A, for example, to a local government, etc.

Here, if the MCI value is “2”, the section is evaluated such that the section is to be monitored. Further, if the MCI value is “1”, the section is evaluated such that the section is to be repaired. It is noted that, in general, a proportion of the kilometer post sections, which have MCI values less than or equal to “2”, with respect to the inspection target road section is between 5% and 10% or the like. Thus, in this case, in order to find the sections of 5% to 10% required to be monitored, the road surface condition measurement is performed for the whole of the road section A, which leads to decreased cost-effectiveness.

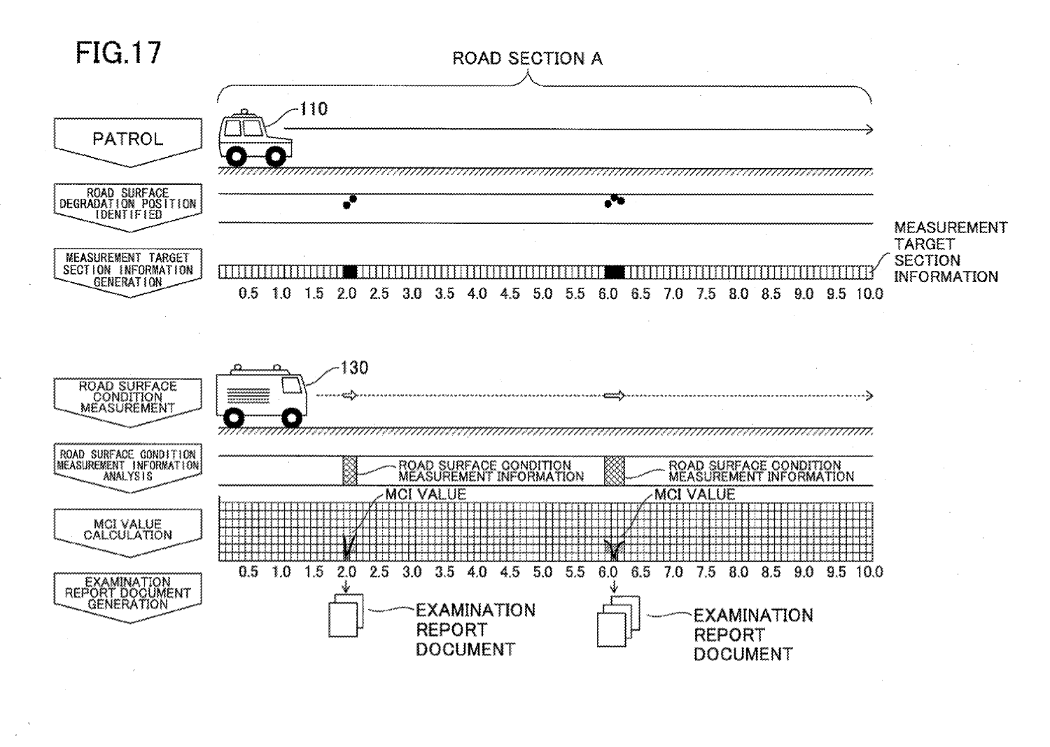

On the other hand, a work flow for inspecting the road pavement using the measurement system 100 of the road surface state according to the first embodiment is illustrated in FIG. 17. FIG. 17 is a first diagram explaining an effect of cut cost related to the inspection of the road surface.

As illustrated in FIG. 17, in the case where the measurement system 100 of the road surface state according to the first embodiment is used, at first, the portable terminal 111 installed in the patrol vehicle 110, which patrols the road section A, obtains the measurement information 510 with respect to the whole of the road section A. Then, the server apparatus 120 receives the measurement information 510 from the portable terminal 111, identifies the road surface degradation position(s) via the comparison with the predetermined threshold, and then generates the measurement target section information.

Then, the road surface condition measurement apparatus 131 performs the road surface condition measurement with respect to only the kilometer post section(s) identified by the measurement target section information. Further, the analysis of the road surface condition measurement information and the calculation of the MCI values are not performed for the road section A as a whole but for only the kilometer post section(s) identified by the measurement target section information.

In this way, according to the measurement system 100 of the road surface state according to the first embodiment, the section in which the road surface condition measurement with the road surface condition measurement apparatus 131 is performed can be made shorter, and time and human effort required for the analysis of the road surface condition measurement information and the calculation of the MCI values can be substantially cut. As a result of this, it becomes possible to cut cost related to the inspection of the road surface.

For example, if it is assumed that cost per 100 m (1 kilometer post section) required to have the road surface condition measurement vehicle 130 travel to derive the MCI values is ten thousand yen, the cost related to the inspection of the road surface with respect to the road section A (10 km long) can be calculated as follows.

### [Conventional Case]

ten thousand yen×100 kilometer post sections=1 million yen.

[Case where Measurement System 100 is Used]

ten thousand yen×5 kilometer post sections=fifty thousand yen.

In this way, in the case where the measurement system 100 of the road surface state is used, a great economical effect can be obtained.

### Second Embodiment

The measurement target section information generation part 702 according to a second embodiment generates, if a plurality of kilometer post sections are successive, the measurement target section information by storing the start point of the first kilometer post section and the end point of the last kilometer post section.

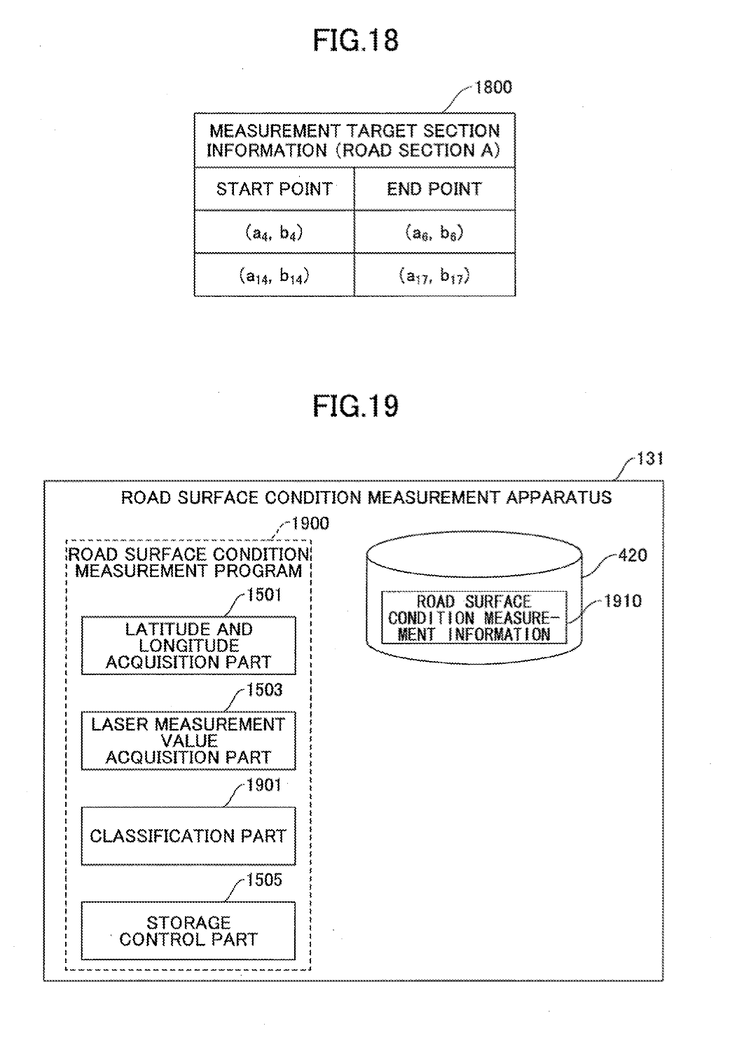

FIG. 18 is a diagram illustrating another example of the measurement target section information stored in the server. FIG. 18 is a diagram illustrating measurement target section information 1800 generated by the measurement target section information generation part 702 according to the second embodiment.

Here, according to the measurement target section information generation part 702 of the first embodiment described above, the measurement target section information 323 is generated by storing the start and end points of the kilometer post section whose “kilometer post section name” is “2.0” and the start and end points of the kilometer post section whose “kilometer post section name” is “2.1”, respectively (see FIG. 11).

In contrast, according to the measurement target section information generation part 702 of the second embodiment, the measurement target section information 1800 is generated by combining the kilometer post sections whose “kilometer post section names” are “2.0” and “2.1”. Specifically, the measurement target section information generation part 702 according to the second embodiment stores the latitude and the longitude of the start point of the kilometer post section whose “kilometer post section name” is “2.0” in the “start point” and the latitude and the longitude of the end point of the kilometer post section whose “kilometer post section name” is “2.1” in the “end point”. In this way, the measurement target section information generation part 702 according to the second embodiment generates the measurement target section information 1800.

Similarly, according to the measurement target section information generation part 702 of the first embodiment described above, the measurement target section information 323 is generated by storing the start and end points of the kilometer post section whose “kilometer post section names” are “6.0”, “6.1”, and “6.2”, respectively (see FIG. 11).

In contrast, according to the measurement target section information generation part 702 of the second embodiment, the measurement target section information 1800 is generated by combining the kilometer post sections whose “kilometer post section names” are “6.0”, “6.1”, and “6.2”. Specifically, the measurement target section information generation part 702 according to the second embodiment stores the latitude and the longitude of the start point of the kilometer post section whose “kilometer post section name” is “6.0” in the “start point” and the latitude and the longitude of the end point of the kilometer post section whose “kilometer post section name” is “6.2” in the “end point”. In this way, the measurement target section information generation part 702 according to the second embodiment generates the measurement target section information 1800.

In this way, the measurement target section information 1800 can be simplified by storing the start point of the kilometer post section at one end of the successive kilometer post sections, and the end point of the kilometer post section at the other end of the successive kilometer post sections.

### Third Embodiment

The road surface condition measurement apparatus 131 according to the third embodiment performs the road surface condition measurement for the road section A as a whole but limits the object to be analyzed to the kilometer post section(s) identified by the measurement target section information 323 or 1800.

Specifically, the road surface condition measurement apparatus 131 according to the third embodiment uses the measurement target section information 323 or 1800 to limit the object to be analyzed in analyzing the road surface condition measurement information. In the following, a function configuration of the road surface condition measurement apparatus 131 according to the third embodiment is described.

FIG. 19 is a diagram illustrating another function configuration of the road surface condition measurement apparatus. The road surface condition measurement apparatus 131 according to the third embodiment implements functions of parts described hereinafter by the CPU 400 executing a road surface condition measurement program 1900. The road surface condition measurement apparatus 131 according to the third embodiment includes a latitude and longitude acquisition part 1501, a laser measurement value acquisition part 1503, a captured image acquisition part 1504, a classification part 1901 and a storage control part 1505.

The latitude and longitude acquisition part 1501 obtains the latitude and the longitude detected by the GPS unit 403.

The laser measurement value acquisition part 1503 obtains laser measurement values detected by the laser scan unit 401 at predetermined cycle. The captured image acquisition part 1504 obtains images captured by the camera image capturing part 402.

The classification part 1901 determines whether the position identified by the obtained latitude and longitude is within the kilometer post section identified by the measurement target section information 323 supplied from the server apparatus 120. Further, if the classification part 1901 determines that the position identified by the obtained latitude and longitude is within the kilometer post section identified by the measurement target section information 323, the classification part 1901 classifies the laser measurement value(s) and captured image(s) obtained at the obtained latitude and longitude into an analysis target group. Further, if the classification part 1901 determines that the position identified by the obtained latitude and longitude is not within the kilometer post section identified by the measurement target section information 323, the classification part 1901 classifies the laser measurement value(s) and captured image(s) obtained at the obtained latitude and longitude into a non-analysis group.

The storage control part 1505 stores road surface condition measurement information 1910 in which the obtained latitude and longitude, the laser measurement values classified into the analysis target group or the non-analysis group, and the captured images classified into the analysis target group or the non-analysis group are associated with date and time of the acquisition thereof in the road surface condition measurement information DB 420.

Next, effects obtained according to the measurement system 100 of the road surface state according to the third embodiment are described.

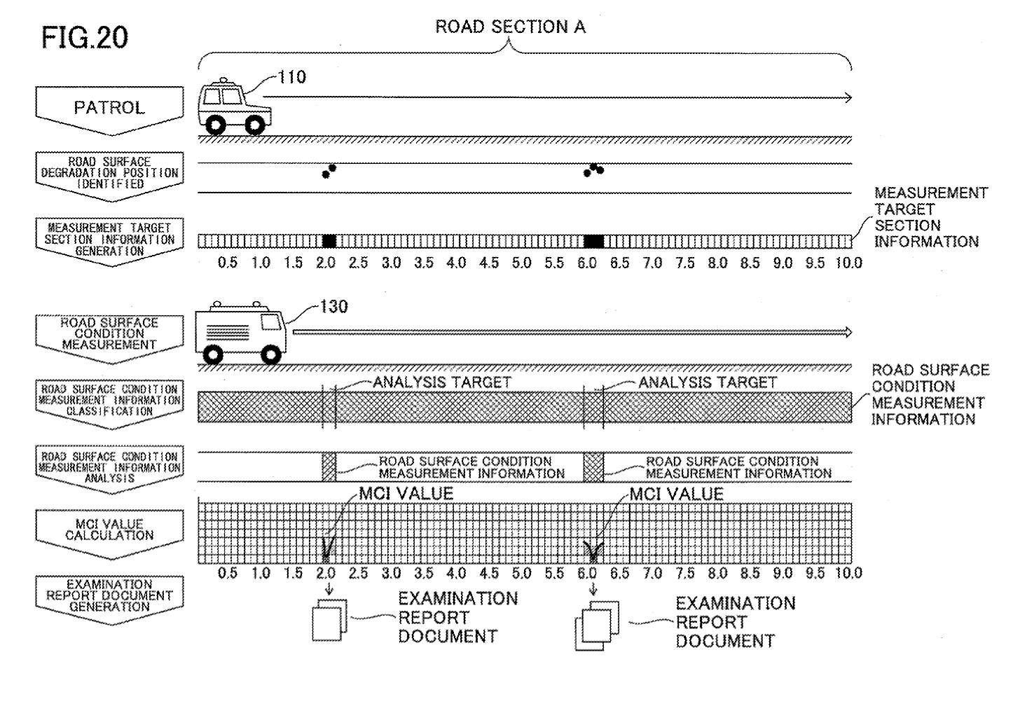

FIG. 20 is a second diagram explaining an effect of cut cost related to the inspection of the road surface. It is noted that, in FIG. 20, the work flow related to the processes until the measurement target section information is generated is the same as that until the measurement target section information 323 is generated according to the first embodiment described with reference to FIG. 17, and thus explanation thereof is omitted.

The difference with respect to FIG. 17 is in that the road surface condition measurement vehicle 130 travels along the road section A as a whole and the road surface condition measurement apparatus 131 performs the road surface condition measurement with respect to the road section A as a whole. Further, the difference is also in that the road surface condition measurement information with respect to the road section A as a whole is stored in the road surface condition measurement information DB 420. Further, the difference is also in that the analysis to derive the MCI value(s) is performed with respect to only the road surface condition measurement information including the laser measurement value(s) and the captured image(s) that are classified by the classification part 1901 into the analysis target group.

In this way, the target to be analyzed is limited to a part of the road surface condition measurement information based on the measurement target section information, and thus time and human effort required for the analysis of the road surface condition measurement information and the calculation of the MCI values can be substantially cut. As a result of this, it becomes possible to cut cost related to the inspection of the road surface.

### Fourth Embodiment

According to the embodiments described above, the measurement target section information 323 generated in the server apparatus 120 is output to the recording medium 150; however, one to which the measurement target section information 323 is output is not limited to a particular object.

For example, if an ordering party terminal is coupled to the network 140, the server apparatus 120 may output the measurement target section information, in response to the access from the ordering party terminal, to the ordering party terminal. It is noted that, the ordering party terminal herein corresponds to a terminal for ordering the road surface condition measurement vehicle 130 (a party who owns it) to make an examination report document of the road surface state. In the following, the fourth embodiment is described in detail.

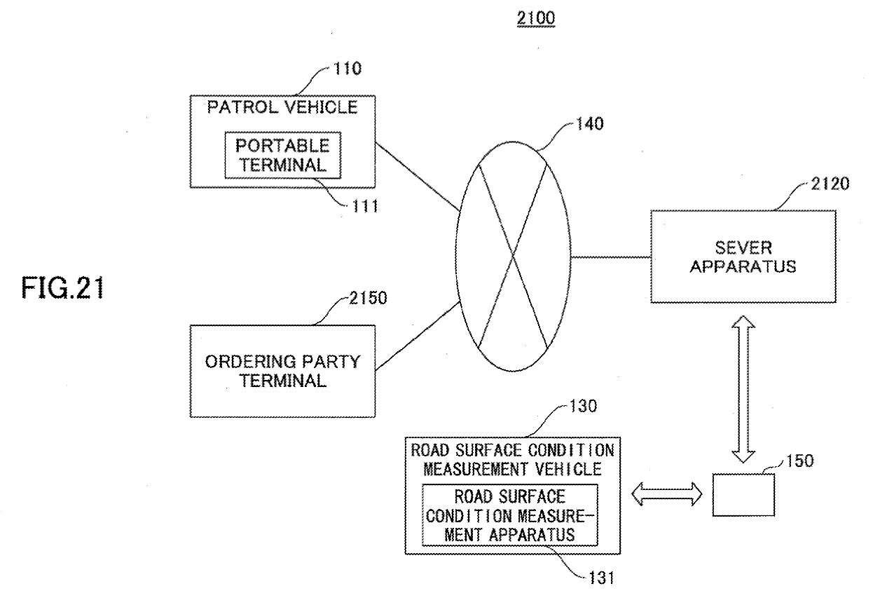

FIG. 21 is a diagram illustrating another example of a measurement system of a road surface state. In FIG. 21, an overall configuration of a measurement system 2100 of the road surface state according to the fourth embodiment is illustrated. It is noted that, here, the explanation is focused on the difference with respect to the overall configuration of the measurement system 100 of the road surface state according to the first embodiment described above with reference to FIG. 1.

In FIG. 21, an ordering party terminal 2150 is used by the ordering party who orders the inspection work of the road surface to be performed by the party (referred to as “measurement party”) who has the road surface condition measurement vehicle 130, and is coupled to the network 140.

On the ordering party terminal 2150, in ordering the inspection working of the road surface to be performed by the measurement party, the ordering party designates a predetermined road section and transmits the acquisition demand of the measurement target section information to a server apparatus 2120.

The server apparatus 2120 reads the measurement target section information 323 of the road section (the road section A, for example) designated by the acquisition demand of the measurement target section information from the section recognition DB 320, and outputs the read measurement target section information 323 to the ordering party terminal 2150.

On the ordering party terminal 2150, an order document data, which includes identification information for identifying the kilometer post section(s) identified by the measurement target section information 323 obtained from the server apparatus 2120, is generated. Then, the ordering party terminal 2150 transmits the order document data to a terminal apparatus the measurement party owns, for example.

In the embodiment, the measurement party controls the road surface condition measurement apparatus 131 such that the road surface condition measurement is performed based on the identification information of the kilometer post section(s) included in the order document data to obtain the road surface condition measurement information of the measurement result. Further, the measurement party may use the terminal apparatus thereof to generate, based on the road surface condition measurement information, examination report document data of the kilometer post section(s) included in the ordering document data, and transmit the examination report document data to the ordering party terminal 2150.

In this way, according to the measurement system 2100 of the road surface state according to the fourth embodiment, the measurement target section information generated by the server apparatus 2120 is utilized as the kilometer post section(s) included in the ordering document data generated in ordering the inspection working of the road surface.

It is noted that, according to the explanation above, the server apparatus 2120 immediately outputs the corresponding measurement target section information 323 in response to the acquisition demand of the measurement target section information 323 from the ordering party terminal 2150; however, a way of outputting the measurement target section information 323 is not limited to the way.

For example, the server apparatus 2120 provides utilization service of the measurement target section information 323, and bills the issuer who issues the acquisition demand of the measurement target section information 323.

Specifically, the server apparatus 2120 may output the measurement target section information on condition that a utilization fee is paid by the issuer who issues the acquisition demand of the measurement target section information via the ordering party terminal 2150. Alternatively, the server apparatus 2120 may resister, in advance, terminals or demanders that can access the measurement target section information on condition that a predetermined utilization fee is paid. In this case, the server apparatus 2120 may output the measurement target section information when the measurement target section information is accessed from the terminals or the demanders.

### Fifth Embodiment

According to the embodiments described above, the acceleration in the up-and-down direction is used as the information related to the vibration of the patrol vehicle 110; however, the information related to the vibration is not limited to the acceleration in the up-and-down direction. For example, an angular velocity may be detected or a vibration amplitude may be detected.

It is noted that the present invention is not limited to configurations disclosed herein, such as the configurations in the embodiments described above and any combination with other elements. With respect to these points, various changes could be determined appropriately without departing from the spirit of the invention, and applications thereof could be determined appropriately.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A method of measuring a road state, the method comprising:
extracting, based on measurement values of an acceleration sensor obtained when a vehicle having the acceleration sensor installed therein travels a predetermined road section, a measurement target section in which an MCI value is to be measured, the measurement target section being a part of the predetermined road section and including a road surface that meets a predetermined degradation criteria, and
limiting, to the measurement target section that is the part of the predetermined road section, a measurement target in which the MCI value is to be measured using a road surface condition measurement vehicle having laser scanning and camera image capturing functions.

2. The method of claim 1, wherein limiting includes limiting a measurement process with the laser scanning function and an image capturing process with the camera image capturing function to the measurement target section.

3. The method of claim 1, wherein the method includes limiting an analysis process for a measurement result measured by the laser scanning function and an analysis process for captured images captured by the camera image capturing function to the measurement target section.

4. A method of identifying a degradation point of a road surface, the method comprising:
identifying, based on a travel position of the vehicle and a state of a road surface that are measured by sensors installed in a vehicle, a road surface position that meets a predetermined degradation criteria;
calculating, based on layout position information of kilometer posts on the road surface, a kilometer post section including the identified road surface position; and
outputting information with which the calculated kilometer post section is identified.

5. The method of claim 4, wherein calculating the kilometer post section includes calculating successive kilometer post sections as a section between two kilometer posts that are located at ends of the successive kilometer post sections when the identified road surface positions are included in the successive kilometer post sections, respectively.

6. The method of claim 4, wherein outputting the information includes a process of outputting the information with which the calculated kilometer post section is identified as a calculation target section in which an MCI value is to be measured, the calculation target section being in an order document related to a measurement of the MCI value.

7. The method of claim 4, wherein outputting the information includes a process of outputting in response to an acquisition demand for the calculation target section in a predetermined road section, and billing an issuer of the acquisition demand.

8. An information process apparatus, comprising a processor that executes a process, the process comprising:
extracting, based on measurement values of an acceleration sensor obtained when a vehicle having the acceleration sensor installed therein travels a predetermined road section, a measurement target section of an MCI value, the measurement target section being a part of the predetermined road section and including a road surface that meets a predetermined degradation criteria; and
outputting information for limiting, to the measurement target section that is the part of the predetermined road section, a measurement target in which the MCI value is to be measured using a road surface condition measurement vehicle having laser scanning and camera image capturing functions.

9. An information process apparatus, comprising a processor that executes a process, the process comprising:
identifying, based on a travel position of the vehicle and a state of a road surface that are measured by sensors installed in a vehicle, a road surface position that meets a predetermined degradation criteria;
calculating, based on layout position information of kilometer posts on the road surface, a kilometer post section including the identified road surface position; and
outputting information with which the calculated kilometer post section is identified.

10. A non-transitory computer-readable recording medium having stored there in a program for causing a computer to execute a process, the process comprising:
extracting, based on measurement values of an acceleration sensor obtained when a vehicle having the acceleration sensor installed therein travels a predetermined road section, a measurement target section in which an MCI value is to be measured, the measurement target section being a part of the predetermined road section and including a road surface that meets a predetermined degradation criteria, and
outputting information for limiting, to the measurement target section that is the part of the predetermined road section, a measurement target in which the MCI value is to be measured using a road surface condition measurement vehicle having laser scanning and camera image capturing functions.

11. A non-transitory computer-readable recording medium having stored there in a program for causing a computer to execute a process, the process comprising:
identifying, based on a travel position of the vehicle and a state of a road surface that are measured by sensors installed in a vehicle, a road surface position that meets a predetermined degradation criteria;
calculating, based on layout position information of kilometer posts on the road surface, a kilometer post section including the identified road surface position; and
outputting information with which the calculated kilometer post section is identified.
